(19) United States
(12) Patent Application Publication
(10) Pub. No.: US 2021/0301236 A1
(43) Pub. Date: Sep. 30, 2021

(54) VINEGAR DRIED WITHIN A NATURAL CARRIER

(71) Applicant: Paragon Flavors, Inc., Princeton, NJ (US)

(72) Inventors: Matthew SILLICK, Montgomery, NJ (US); Christopher Mark GREGSON, Princeton, NJ (US)

(73) Assignee: Paragon Flavors, Inc., Princeton, NJ (US)

(21) Appl. No.: 17/211,495

(22) Filed: Mar. 24, 2021

Related U.S. Application Data
(60) Provisional application No. 62/994,017, filed on Mar. 24, 2020.

(51) Int. Cl. C12J 1/02; A23L 7/10; A23L 7/104; A23L 3/46; A23P 10/40

(52) U.S. Cl. CPC C12J 1/02; A23L 7/198; A23V 2002/00; A23L 3/46; A23P 10/40; A23L 7/107

(57) ABSTRACT

A solid vinegar powder and a method to generate the solid vinegar powder is described. The powder comprises an amount of acetic acid in a range of approximately 5% to approximately 50%, an amount of malted wholegrain seed or flour in a range of approximately 50% to approximately 95%, and at least 1% of nutritional components from the malted wholegrain seed or flour that includes fats, proteins, minerals and fibers. The solid vinegar powder is free from an addition of maltodextrin, dextrin, sodium diacetate, and/or modified starch.

### CROSS-REFERENCE TO RELATED APPLICATIONS SECTION

This application is a U.S. Non-Provisional patent application that claims priority to U.S. Provisional Patent Application Ser. 62/994,017 filed on Mar. 24, 2020, the entire contents of which are hereby incorporated by reference in their entirety.

### FIELD OF THE EMBODIMENTS

The field of the invention and its embodiments relate to a solid vinegar powder and a method to generate a solid vinegar powder. In particular, the present invention and its embodiments provide a solid vinegar powder free from an addition of carbohydrate gums, maltodextrin, dextrin, sodium diacetate, and/or modified starch.

### BACKGROUND OF THE EMBODIMENTS

As individuals become increasingly concerned with their health, consumers are demanding all-natural and whole food sources for consumption. Items, such as vinegar powder, may be used in numerous and flavorful ways to enhance food products, such as being added to stews, chilis, soups, dressings, marinades, and dry rubs, among other food products not mentioned. Current techniques to create vinegar powder include either neutralizing the vinegar to precipitate sodium diacetate or by enrobing and spray drying an acidic vinegar within carriers of carbohydrate gum or dextrin. In these examples, the resulting vinegar powder contains numerous highly refined ingredients, which are less preferred by consumers who are looking for all-natural food options. Some of these highly refined ingredients include carbohydrate gums, maltodextrin, dextrin, sodium diacetate, and/or modified starch.

A carbohydrate gum is a polysaccharide that produces a gel of a viscous solution when it is dispersed in water at low concentrations. These gums are popular additives in food products as thickeners and stabilizers. Common examples of carbohydrate gums include: agar, guar gum, xanthan gum, gum arabic, and sodium carboxymethyl cellulose. However, some are concerned with the health risks of these gums. For example, in higher intakes, xanthan gum may increase the risk of digestive problems and may cause flu-like symptoms, nose and throat irritation, and/or lung problems.

Maltodextrin is a polysaccharide that is used as a food additive and is produced from vegetable starch by partial hydrolysis. Maltodextrin is typically found as a white hygroscopic spray-dried powder that is highly-refined. Dextrins are a group of low-molecular-weight carbohydrates produced by the hydrolysis of starch or glycogen. Dextrins may be either yellow or white. Yellow dextrins may be used as water-soluble glues. White dextrins may be used in the food industry as a crispness enhancer for food processing, in food batters, coatings, and glazes.

Sodium diacetate is a white, hygroscopic, crystalline solid having an odor of acetic acid and is a mixture of sodium acetate and acetic acid. Sodium diacetate is used in food as a sour agent and pH regulator. Modified starch is starch extracted from grains and vegetables, which has been treated to improve its ability to keep the texture and structure of the food. Since modified starch is treated with chemicals, such as octenyl succinic anhydride, sodium hypochlorite or propylene oxide, modified starch is not considered to be a natural food by consumers.

The current technical field requires a solution to generate a flavorful dried vinegar powder that delivers the benefit of being present in a solid form, while also avoiding these highly refined and chemically-derived ingredients. No current technical solution provides such.

### Review of Related Technology

RU 2,494,627 C describes a method for the production of grain bread. The method includes: soaking a whole unshelled wheat grain, dispersing it, adding to the obtained grain mass recipe components, kneading dough, fermenting, cutting, proofing and baking dough pieces.

U.S. Pat. No. 6,613,366 B1 describes a class of food products whose nutrients have not been damaged by heat during the preparation process. These products are prepared with methods to limit souring, thus permitting these food products to be prepared at a temperature low enough to minimize damage to vital nutrients (especially enzymes) without the objectionable excessive sourness and bitterness of similar products prepared without such methods. The result is a class of delicious and nutrient rich health food products with many health benefits.

U.S. Pat. No. 3,445,244 A describes a composition comprising up to 60% spray dried vinegar enrobed in a spray dried member (e.g., gelatin or gluten) consisting of 25 to 95% carbohydrate gums and 30 to 95% dextrin.

JP 2009/039016 A describes a method for producing black vinegar by using germinated unpolished rice as a raw material and losing a small amount of GABA (gamma-aminobutyric acid). The black vinegar is obtained by completely boiling the whole unpolished rice grain germinated by immersing the unpolished rice with water, adding a liquefaction-promoting enzyme to the rice in its granular state together with immersion water to liquefy, then performing a saccharification treatment, an alcoholic fermentation and an acetic acid fermentation.

JP 2006/212025 A describes a dried powdered food preferable that lasts for a long time period and is easily ingestible without cooking. The dried powdered food contains at least whole-grain dried powder of cereal and whole dried powder of at least each one kind selected from leaf vegetables, root vegetables and fruit vegetables.

CN 103907493 A describes an integrated technology for organic rice scale production. The integrated technology for the organic rice scale production is a feasible technology for organic rice large-area production, disease prevention, weed killing, pest prevention, seedling sounding, and fertilizer planning and management.

CN 104351660 B describes a method to prepare a sprouted unpolished rice of high GABA content.

CN 105586242 A describes a method of making whole-grain millet vinegar rich in GABA. The raw material for this method is germinated foxtail millet.

CN 104351773 A describes a yellow ginseng and kudzu vine blood-glucose-reducing granule health food that includes multiple drugs (e.g., okra, ginseng, the root of kudzu vine, selenium-enriched black bean sprout powder, Chinese yam, Chinese magnoliavine fruit, etc.).

Various methods to generate solid vinegar powders are known in the art. However, their means of operation are substantially different from the present disclosure, as the other inventions fail to solve all the problems taught by the present disclosure. The present invention and its embodiments provide a solid vinegar powder and a method to generate a solid vinegar powder. In particular, the present invention and its embodiments provide a solid vinegar powder free from an addition of carbohydrate gums, maltodextrin, dextrin, and/or modified starch.

### SUMMARY OF THE EMBODIMENTS

The present invention and its embodiments provide a solid vinegar powder and a method to generate a solid vinegar powder. In particular, the present invention and its embodiments provide a solid vinegar powder free from an addition of carbohydrate gums, maltodextrin, dextrin, and/or modified starch.

A first embodiment of the instant invention describes a solid vinegar powder. The solid vinegar powder includes: an amount of acetic acid in a range of approximately 5% to approximately 50%, an amount of malted wholegrain seed or flour in a range of approximately 50% to approximately 95%, and at least 1% of nutritional components from the malted wholegrain seed or flour. The solid vinegar powder is free from an addition of carbohydrate gums, maltodextrin, dextrin, sodium diacetate, and/or modified starch. In examples, the malted wholegrain seed or flour is unfermented. In additional examples, the nutritional components from the malted wholegrain seed or flour are preserved. In examples, the nutritional components from the malted wholegrain seed or flour include: fats, proteins, minerals and/or fibers.

A second embodiment of the instant invention describes a method to generate a vinegar powder. The vinegar powder is free from an addition of carbohydrate gums, maltodextrin, dextrin, sodium diacetate, and/or modified starch. The method includes numerous process steps, such as: sprouting or germinating a seed to activate one or more enzymes of the seed or a subsequently derived flour. The subsequently derived flour includes approximately 400 grams of a brown rice flour. The method may also include combining an amount of the seed or the subsequently derived flour with approximately 600 grams of water at a first temperature in a range of approximately 15° C. to approximately 80° C. to form a preparation. In examples, the first temperature is approximately 60° C. The method may additionally include optionally mechanically treating the preparation to provide access of the one or more enzymes to starch molecules. The one or more enzymes may include: diastase, amylase, and/or protease, among others not explicitly listed herein.

The method may further include: mashing the preparation for approximately 90 minutes to achieve a brix value of at least half of a percentage of the seed or the subsequently derived flour in the preparation. In examples, the brix value is above 30. In further examples, the method may include optionally concentrating the preparation using a non-thermal technique and cooling the concentrated preparation to a second temperature below 90° C. In examples, the second temperature is approximately 50° C. In further examples, the method may also include: mixing the cooled preparation with vinegar. In examples, the vinegar is a natural vinegar and may include: an apple cider vinegar, a balsamic vinegar, a red wine vinegar, a white wine vinegar, a sherry vinegar, a fig vinegar, a cranberry vinegar, an acerola vinegar, a malt vinegar, and/or a rice vinegar, among others not explicitly listed herein. In other examples, the vinegar is an approximately 30% white vinegar and is included in an amount of approximately 400 grams. Additionally, the method may include drying the mixture to form a dried vinegar. In examples, the step of drying the mixture occurs via a food dehydrator.

In general, the present invention succeeds in conferring the following benefits and objectives.

It is an object of the present invention to provide a solid vinegar powder free from an addition of carbohydrate gums, maltodextrin, dextrin, sodium diacetate, and/or modified starch.

It is an object of the present invention to provide a solid vinegar powder containing only natural ingredients.

It is an object of the present invention to provide a solid vinegar powder useful as a dry seasoning for one or more food products.

It is an object of the present invention to provide a solid vinegar powder useful as a natural food preservative.

It is an object of the present invention to provide a solid vinegar powder useful for dosing vinegar into applications (such as sausages) where a liquid form of vinegar would carry in too much water.

It is an object of the present invention to provide a solid vinegar powder that uses a whole unrefined grain and imparts all nutrients of the whole grain to the vinegar powder.

It is an object of the present invention to provide a whole grain has been sprouted or malted to produce a suitable encapsulation carrier for vinegar.

### BRIEF DESCRIPTION OF THE DRAWINGS

FIG. 1 depicts a block diagram of a method to generate a vinegar powder, according to at least some embodiments described herein.

### DESCRIPTION OF THE PREFERRED EMBODIMENTS

The preferred embodiments of the present invention will now be described with reference to the drawings. Identical elements in the various FIGURES are identified with the same reference numerals.

Reference will now be made in detail to each embodiment of the present invention. Such embodiments are provided by way of explanation of the present invention, which is not intended to be limited thereto. In fact, those of ordinary skill in the art may appreciate upon reading the present specification and viewing the present drawings that various modifications and variations can be made thereto.

Typical vinegar powders may be used in numerous and flavorful ways to enhance food products, such as being added to stews, chilis, soups, dressings, marinades, and dry rubs, among other food products not mentioned. Current techniques to create vinegar powders include either neutralizing the vinegar to precipitate the sodium diacetate or by enrobing and spray drying an acidic vinegar within carriers of carbohydrate gum or dextrin. However, the resulting vinegar powder contains numerous highly refined ingredients, which are less preferred by consumers who are looking for all-natural food options. Some of these highly refined ingredients include carbohydrate gums, maltodextrin, dextrin, sodium diacetate, and/or modified starch.

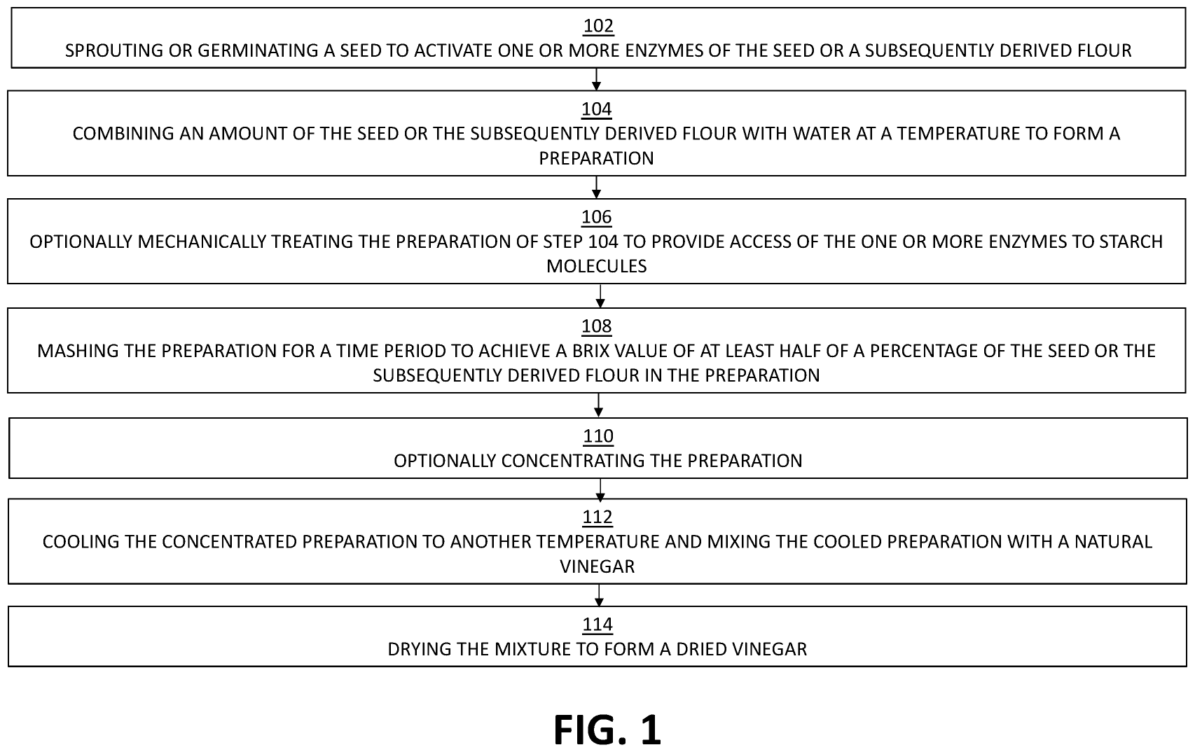

Instant FIG. 1 provides a flowchart for a method to generate a vinegar powder free from an addition of carbohydrate gums, maltodextrin, dextrin, sodium diacetate, and/or modified starch. A flowchart for a method to generate a vinegar powder is depicted in FIG. 1. The method may start at a process step 102, that includes sprouting or germinating a seed to activate one or more enzymes of the seed or a subsequently derived flour. According to some examples, the subsequently derived flour may be a malted wholegrain flour. In other examples, the subsequently derived flour may be an unfermented malted wholegrain flour. In further examples, the subsequently derived flour is a sprouted brown rice flour. The one or more enzymes may include: diastase, amylase, and/or protease, among other amylolytic enzymes not explicitly described herein. FIG. 1 provides an improvement compared to simply plating vinegar onto raw flour.

The process step 102 is followed by a process step 104, where an amount of the seed or the subsequently derived flour is combined with approximately 600 grams of water at a first temperature in a range of approximately 15° C. to approximately 80° C. to form a preparation. The subsequently derived flour may be a sprouted brown rice flour and may be present in approximately 400 grams. In examples, the first temperature is approximately 60° C.

The process step 104 is followed by a process step 106, where the water-flour mixture (e.g., the preparation) is optionally mechanically treated to provide access of the one or more enzymes to starch molecules. Mechanically treating the flour mash can liberate starch granules from the flour matrix, enhance a starch gelatinization rate, and disperse starch molecules so as to make them more exposed to the action of enzymes. The process step 104 results in a more controlled hydrolysis and a narrow molecular weight distribution.

The process step 106 is followed by a process step 108, where the preparation is mashed for approximately 90 minutes to achieve a brix value, expressed as degrees Brix (° Bx), which is indicitive of refractive index. The brix value of the process step 108 is at least half of a percentage of the seed or the subsequently derived flour in the preparation. In examples, the brix value is above 30. According to some examples, the process step 108 may occur via a thermal blender. The mashing step may convert the flour into a soluble natural carrier for enrobing.

The process step 108 is followed by a process step 110, where the preparation is optionally concentrated to achieve a solids level of the preparation above 40% to dehydrate the preparation ahead of adding an aqueous vinegar solution. The process step 110 is followed by a process step 112, where the concentrated preparation is cooled to a second temperature below 90° C. and then is mixed with approximately 400 grams of a vinegar. In examples, the second temperature is 50° C. In examples, the vinegar is a natural vinegar, which may include: an apple cider vinegar, a balsamic vinegar, a red wine vinegar, a white wine vinegar, a sherry vinegar, a fig vinegar, a cranberry vinegar, an acerola vinegar, a malt vinegar, and/or a rice vinegar, among other examples not explicitly described herein. In further examples, vinegar is an approximately 30% white vinegar and is included in an amount of approximately 400 grams. In other examples the vinegar is concentrated prior to the step 110 by freeze concentration or distillation. In some examples, the vinegar is concentrated using a non-thermals technique, such as reverse and forward osmosis.

The process step 112 is followed by a process step 114, where the mixture is dried, via spray drying, with an inlet temperature between approximately 80° C. and approximately 200° C. and an outlet temperature between approximately 50° C. and approximately 100° C. to instantly form a dried vinegar powder. The process step 114 may occur for approximately 4 hours. In other examples, the process step 114 may occur via a convection oven or a food dehydrator. The process step 114 ends the method to generate the vinegar powder in FIG. 1.

An instant example applying the method to generate the vinegar powder of FIG. 1 is described herein. The step 102 includes sprouting or germinating a seed to activate one or more enzymes of the seed or a subsequently derived flour. The step 104 includes combining an amount of the seed or approximately 400 grams of the subsequently derived flour with approximately 600 grams of water at a first temperature in a range of approximately 15° C. to approximately 80° C. to form a preparation. The step 106 includes optionally mechanically treating the preparation of step 104 to enhance access of the one or more enzymes to starch molecules. The step 108 includes mashing the preparation for approximately 90 minutes in a thermal blender, such as a Bellini model blender, to achieve a brix value of at least half of a percentage of the seed or the subsequently derived flour in the preparation. The step 110 includes optionally concentrating the preparation by boiling. The step 112 includes cooling the concentrated preparation to a second temperature below 90° C. The step 112 may also include mixing the cooled preparation of with 400 grams of a 30% white vinegar by stirring. The step 114 may include casting the preparation into a thin film and drying the preparation within a Nesco FD-75 food dehydrator for approximately 4 hours at 50° C. to create a dried vinegar.

The vinegar powder generated by the method of FIG. 1 is a solid vinegar powder that uses a whole unrefined grain and imparts all of the nutrients of the whole grain to the vinegar powder. The vinegar powder also fails to contain an added carbohydrate gums, maltodextrin, dextrin, and/or modified starch, and thus, provides the benefit of having a solid composition or configuration, while including less refined ingredients prior to current methods in the field. Moreover, the vinegar powder generated by the method of FIG. 1 includes: an amount of acetic acid in a range of approximately 5% to approximately 50%, an amount of malted wholegrain seed or flour in a range of approximately 50% to approximately 95%, and at least 1% of nutritional components from the malted wholegrain seed or flour. In examples, the malted wholegrain seed or flour is unfermented. In examples, the nutritional components from the malted wholegrain seed or flour may include fats, proteins, minerals, and/or fibers. In other examples, the nutritional components from the malted wholegrain seed or flour are preserved. The vinegar powder generated by the method of FIG. 1 may be useful as a dry seasoning for one or more food products, as a natural preservative, as a meat tenderizer, and/or for dosing vinegar into applications (such as sausages) where a liquid form of vinegar would carry in too much water.

The present invention also describes a method to create a spray dried vinegar. In this illustrative example, rice flour is spray-dried twice, but the method follows the process described for FIG. 1 if the first spray drying is considered to occur at the process step 110. Specifically, according to this method to create the spray dried vinegar, approximately 800 grams of malted sweet rice flour (Eckert Malting, Chico, Calif.) is first combined with approximately 1200 grams of water at approximately 70° C. and is mixed for approximately 90 minutes to create a feed suitable for spray drying. Next, the mixture is homogenized using a Silverson L5M-A mixer for approximately 10 minutes at approximately 10,000 rpm. The mixture is then spray dried using a Toption TP-S50 pilot spray dryer with a rotary atomization wheel. It should be appreciated that an inlet temperature is approximately 140° C. and an outlet temperature is approximately 100° C. Next, the method includes recovering the spray-dried rice flour.

A measure of approximately 500 grams of the spray-dried rice flour may then be reconstituted with an addition of approximately 500 grams of 30% white vinegar. This mixture may then be homogenized using the Silverson 15M-A mixer for approximately 10 minutes at approximately 10,000 rpm. The feed has a pH value of 3.0. The mixture is then spray dried with the inlet temperature of approximately 120° C. and the outlet temperature of approximately 80° C. to create a vinegar/rice flour powder, which possesses a potent vinegar character.

When introducing elements of the present disclosure or the embodiments thereof, the articles “a,” “an,” and “the” are intended to mean that there are one or more of the elements. Similarly, the adjective “another,” when used to introduce an element, is intended to mean one or more elements. The terms “including” and “having” are intended to be inclusive such that there may be additional elements other than the listed elements.

Although this invention has been described with a certain degree of particularity, it is to be understood that the present disclosure has been made only by way of illustration and that numerous changes in the details of construction and arrangement of parts may be resorted to without departing from the spirit and the scope of the invention.

What is claimed is:

1. A solid vinegar powder comprising:
an amount of acetic acid in a range of approximately 5% to approximately 50%;
an amount of malted wholegrain seed or flour in a range of approximately 50% to approximately 95%; and
at least 1% of nutritional components from the malted wholegrain seed or flour.

2. The solid vinegar powder of claim 1, wherein the malted wholegrain seed or flour is unfermented.

3. The solid vinegar powder of claim 1, wherein the nutritional components from the malted wholegrain seed or flour are selected from the group consisting of: fats, proteins, minerals and fibers.

4. The solid vinegar powder of claim 1, wherein the nutritional components from the malted wholegrain seed or flour are preserved.

5. The solid vinegar powder of claim 1, wherein the solid vinegar powder is free from an addition of carbohydrate gums, maltodextrin, dextrin, sodium diacetate, and/or modified starch.

6. A method to generate a vinegar powder, the method comprising:
sprouting or germinating a seed to activate one or more enzymes of the seed or a subsequently derived flour;
combining an amount of the seed or the subsequently derived flour with an amount of water at a first temperature in a range of approximately 15° C. to approximately 80° C. to form a preparation;
optionally mechanically treating the preparation to provide access of the one or more enzymes to starch molecules;
mashing the preparation for a first time period to achieve a brix value of at least half of a percentage of the seed or the subsequently derived flour in the preparation;
optionally concentrating the preparation;
cooling the concentrated preparation to a second temperature below 90° C.;
mixing the cooled preparation with vinegar; and
drying the mixture to form a dried vinegar.

7. The method of claim 6,
wherein the subsequently derived flour is a sprouted brown rice flour, and
wherein the amount of the subsequently derived flour is approximately 400 grams.

8. The method of claim 6, wherein the amount of the water is approximately 600 grams.

9. The method of claim 6, wherein the vinegar is a natural vinegar.

10. The method of claim 6, wherein the vinegar is selected from the group consisting of: an apple cider vinegar, a balsamic vinegar, a red wine vinegar, a white wine vinegar, a sherry vinegar, a fig vinegar, a cranberry vinegar, an acerola vinegar, a malt vinegar, and a rice vinegar.

11. The method of claim 6, wherein the first temperature is approximately 60° C.

12. The method of claim 6, wherein the second temperature is approximately 50° C.

13. The method of claim 6, wherein the first time period is approximately 90 minutes.

15. The method of claim 6, wherein the brix value is above 30.

16. The method of claim 6, wherein the vinegar is approximately 30% white vinegar and is included in an amount of approximately 400 grams.

17. The method of claim 6, wherein the one or more enzymes are selected from the group consisting of: diastase, amylase, and protease.

18. The method of claim 6, wherein the vinegar is concentrated using a non-thermal technique.

19. The method of claim 6, wherein the vinegar powder is free from an addition of carbohydrate gums, maltodextrin, dextrin, sodium diacetate, and/or modified starch.

20. The method of claim 6, further comprising:
mixing the subsequently derived flour with water to create a mixture;
homogenizing the mixture;
spray drying the mixture;
recovering spray-dried rice flour;
reconstituting the spray-dried rice flour with white vinegar to form another mixture;
homogenizing the other mixture; and
spray drying the other mixture to create a flour powder.
